(19) United States
(12) Patent Application Publication
(10) Pub. No.: US 2026/0020001 A1
(43) Pub. Date: Jan. 15, 2026

(54) DECIMATED RESOURCE BLOCK MAPPING FOR IMPROVED POWER FLUX DENSITY-LIMITED LINK BUDGET IN DIRECT-TO-UE MILLIMETER WAVE NON-TERRESTRIAL NETWORK

(71) Applicant: QUALCOMM Incorporated, San Diego, CA (US)

(72) Inventors: Yehonatan DALLAL, Kfar Saba (IL); Gideon Shlomo KUTZ, Ramat Hasharon (IL); Idan Michael HORN, Hod Hasharon (IL)

(21) Appl. No.: 18/773,252

(22) Filed: Jul. 15, 2024

(51) Int. Cl. H04W 72/044; H04L 5/00; H04W 56/00; H04W 84/06

(52) U.S. Cl. CPC H04W 72/044; H04L 5/0051; H04W 56/0015; H04W 84/06

(57) ABSTRACT

The apparatus may be a wireless device (e.g., a UE) or a component thereof configured to obtain a flexible resource block (FRB) configuration for a FRB comprising a set of activated resource elements (REs) associated with the FRB configuration in each of a plurality of physical resource blocks (PRBs) and receive, based on the FRB configuration, a transmission via at least one FRB. The apparatus may be a network node (e.g., a satellite or other network device associated with a NTN) or a component thereof configured to transmit a FRB configuration for a FRB comprising a set of activated REs associated with the FRB configuration in each of a plurality of PRBs and transmit, based on the FRB configuration, a transmission via at least the FRB.

### TECHNICAL FIELD

The present disclosure relates generally to communication systems, and more particularly, to a resource mapping for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device (e.g., a user equipment (UE)) or a component thereof configured to obtain a flexible resource block (FRB) configuration for a FRB comprising a set of activated resource elements (REs) associated with the FRB configuration in each of a plurality of physical resource blocks (PRBs) and receive, based on the FRB configuration, a transmission via at least one FRB.

In an aspect of the disclosure, a method, a computer-readable medium, and an apparatus are provided. The apparatus may be a network node (e.g., a satellite or other network device associated with a non-terrestrial network (NTN)) or a component thereof configured to transmit a FRB configuration for a FRB comprising a set of activated REs associated with the FRB configuration in each of a plurality of PRBs and transmit, based on the FRB configuration, a transmission via at least the FRB.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4 is a set of diagrams illustrating aspects of signal transmission in the presence of an imposed PFD limit.

FIG. 5 is a diagram illustrating a configuration of a FRB for communication between a network node of a NTN and a wireless device in accordance with some aspects of the disclosure.

FIG. 6 is a diagram illustrating a configuration of multiple (coordinated) FRBs for communication between multiple network nodes of a same NTN and multiple wireless devices in accordance with some aspects of the disclosure.

FIG. 7 is a call flow diagram illustrating a method of wireless communication in accordance with some aspects of the disclosure.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

FIG. 14 is a diagram illustrating an example of a hardware implementation for an example network entity.

### DETAILED DESCRIPTION

In some aspects of wireless communications, a NTN may provide direct to cellular (or direct-to-cellular) connectivity from one or more satellites, e.g., satellites in a low earth orbit (LEO), other NTN nodes/devices, or a high-altitude platform station (HAPS) (as examples of network nodes that may be associated with an imposed and/or applied power flux density (PFD) limit). NTN communications and/or transmissions, in some aspects, may be governed by regulatory bodies, authorities, and/or agencies (e.g., the Federal Communications Commission (FCC) or the International Telecommunication Union (ITU)). For example, such regulators may provide for frequency bands for “supplemental coverage from space.” Several frequency bands have been identified all of which are below 2 GHz. As interest in direct-to-cellular services increases globally and recognizing that large bandwidths facilitating large throughputs are available using millimeter wave (mmW) signals, it may be expected that additional frequency bands for supplemental coverage from space may be declared in the FR2 region of spectrum (e.g., 24.25 GHz-52.6 GHz). However, one or more regulatory bodies/authorities/agencies may place limitations on a PFD measured on the Earth's surface within certain bands that are being considered for FR2 from a NTN (e.g., from space and/or LEO). For example, based on sharing FR2 (or other additional frequency bands for supplemental coverage from space) between several services, the one or more regulatory bodies/authorities/agencies may place limitations on the power flux density measured on Earth. The PFD may be defined in terms of decibel watts per meter squared per second (dBW/m²) and/or in terms of dBW/m² per Hertz

$$( \frac{d B W}{{m}^{2} H z} )$$

and may be further defined in association with a reference frequency range and/or bandwidth (e.g., over a 4 kHz or 1 MHz frequency range). For a PFD limit defined in association with a reference bandwidth, the PFD limit may be understood to be a limit on the total PFD (defined in terms of dBW/m²) within the reference bandwidth and/or the average PFD (defined in terms of

$$\frac{d B W}{{m}^{2} H z} )$$

over the reference bandwidth. In some aspects, the PFD may be dependent on an angle of arrival of the NTN signal.

The (maximum) power accepted and/or received at wireless device (e.g., a UE) may be based on the PFD (limit) and an effective antenna area (e.g.,

$${A}_{e} = \frac{{λ}^{2}}{4 π} {G}_{r} ,$$

where Gᵣ is a measure of antenna gain associated with a receiving antenna or antenna array). For example, at a first UE having an effective antenna area (Aₑ) and receiving a signal associated with a PFD (PFDₛ), the received power (Pᵣ) may be given

$${P}_{r} = PF {D}_{s} \times {A}_{e} or {PFD}_{s} \times \frac{{λ}^{2}}{4 π} {G}_{r} ,$$

where a maximum received power (P_{r_max}) based on the PFD limit (PFDₘₐₓ) may be defined as

$${P}_{r \_ max} = {PFD}_{m ax} \times \frac{{λ}^{2}}{4 π} {G}_{r} .$$

For a common mmW UE the receiving antenna or antenna array may be associated with a gain of 10 dBi and, based on a PFD limit (PFDₘₐₓ) of −105 dBW/m² in a 1 MHz frequency range, the maximum received power (P_{r_max}) over the 1 MHz frequency range may be −145 dBW. The maximum received power (P_{r_max}) may be associated with a signal to noise ratio (SNR) of −1 dB even with a receiving device (e.g., an antenna or antenna chain of the receiving device) having a noise figure (NF) equal to zero (e.g., a receiver that introduces no additional noise).

It can be seen that imposing the PFD limit (PFDₘₐₓ) may, in some aspects, result in a negative SNR (e.g., a noise that drowns out a signal) or a SNR that is too low to allow for the receiving device to decode a received signal with a threshold accuracy and/or reliability. In some aspects of wireless communication, a negative SNR based on a transmission power limit may be overcome by reducing a bandwidth such that the total transmission power is below the transmission power limit while, within the reduced bandwidth, the transmission power is greater than a power associated with noise such that a positive SNR is achieved. However, based on the small size (e.g., 1 MHz) of the reference bandwidth used to define the PFD limit for NTN transmissions compared to a single PRB within FR2 (e.g., typically 1.44 MHz or greater based on a sub-carrier spacing (SCS) of 120 kHz or more), this solution may be unavailable for a PRB-based transmission.

Various aspects relate generally to using an “interlace structure” to cope with, or overcome, issues arising from the PFD limitation in FR2-NTN for handsets (e.g., wireless devices and/or UEs). Some aspects more specifically relate to using a FRB that may be mapped to REs or sub-carriers of a plurality of PRBs (e.g., where the mapping may be a configurable, or flexible, mapping) to achieve a positive SNR while not exceeding the PFD limit. In some examples, a UE may be configured to obtain a FRB configuration for a FRB including a set of activated REs associated with the FRB configuration in each of a plurality of PRBs and receive, based on the FRB configuration, a transmission via at least one FRB. In some aspects, a network node (e.g., a satellite) may be configured to transmit a FRB configuration for a FRB including a set of activated REs associated with the FRB configuration in each of a plurality of PRBs and transmit, based on the FRB configuration, a transmission via at least the FRB.

Particular aspects of the subject matter described in this disclosure can be implemented to realize one or more of the following potential advantages. In some examples, by using the FRBs, the described techniques can be used to achieve a threshold (positive) SNR or other measure of link quality while not exceeding a PFD limit (e.g., a PFD limit imposed by one or more regulatory bodies/authorities/agencies such as the ITU or the FCC).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

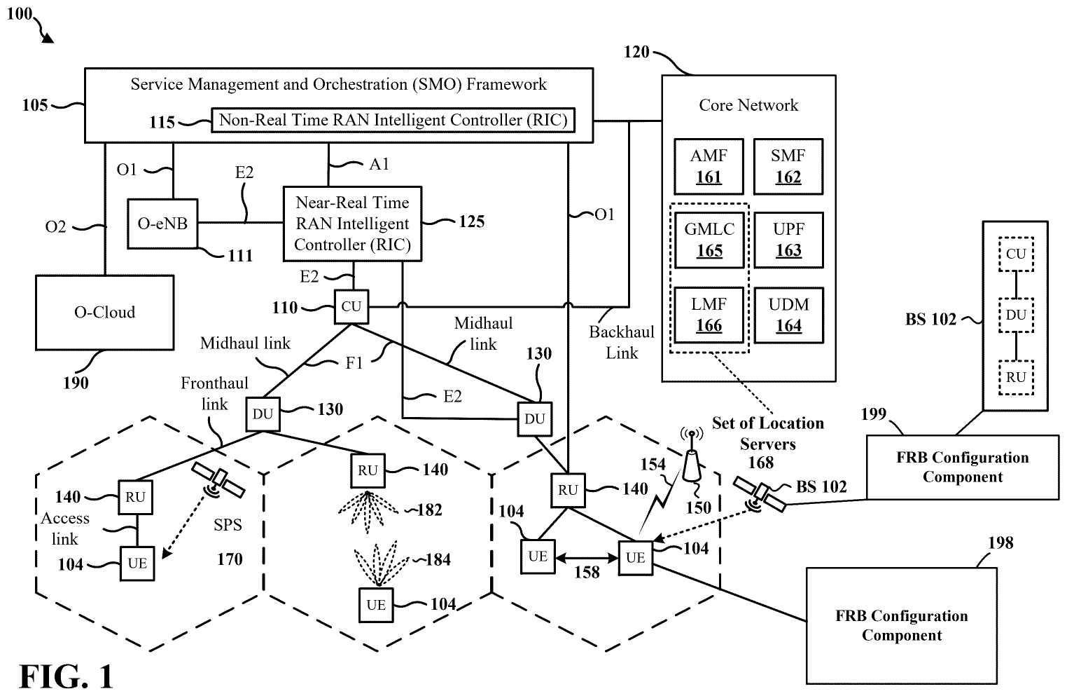

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a FRB configuration component 198 that may be configured to obtain a FRB configuration for a FRB including a set of activated REs associated with the FRB configuration in each of a plurality of PRBs and receive, based on the FRB configuration, a transmission via at least one FRB. In certain aspects, the base station 102 may have a FRB configuration component 199 that may be configured to transmit a FRB configuration for a FRB including a set of activated REs associated with the FRB configuration in each of a plurality of PRBs and transmit, based on the FRB configuration, a transmission via at least the FRB. Although the following description may be focused on NTN communication associated with 5G NR, the concepts described herein may be applicable to other similar areas, such as LTE, LTE-A, CDMA, GSM, and other wireless technologies with imposed power limits.

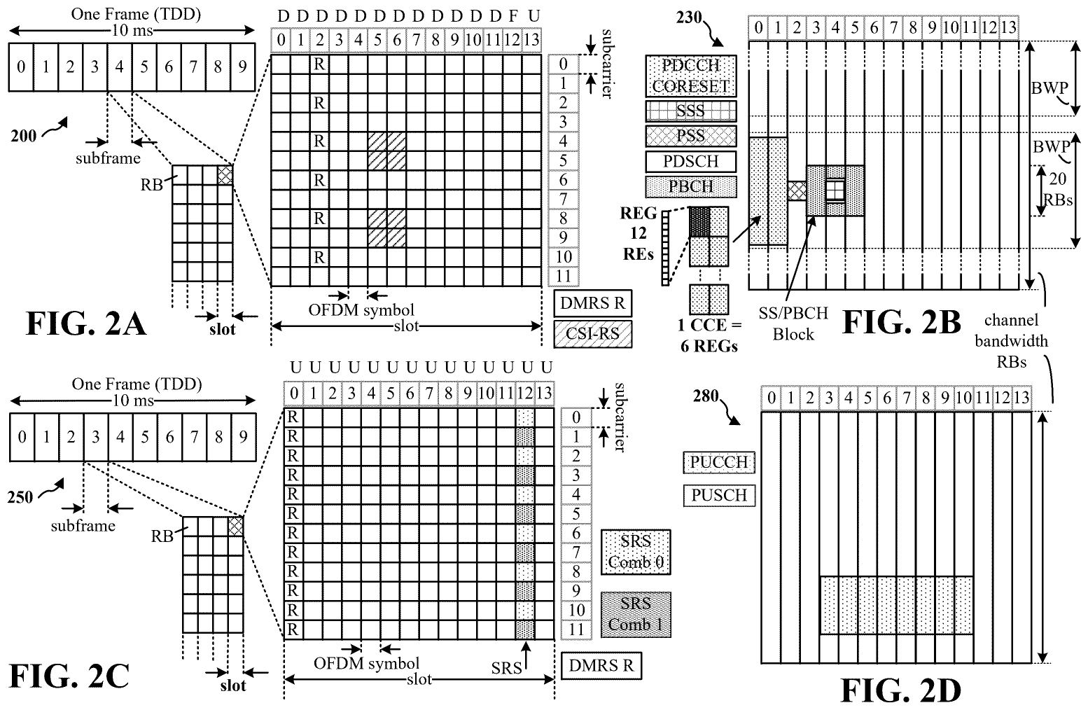

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (or DMRS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

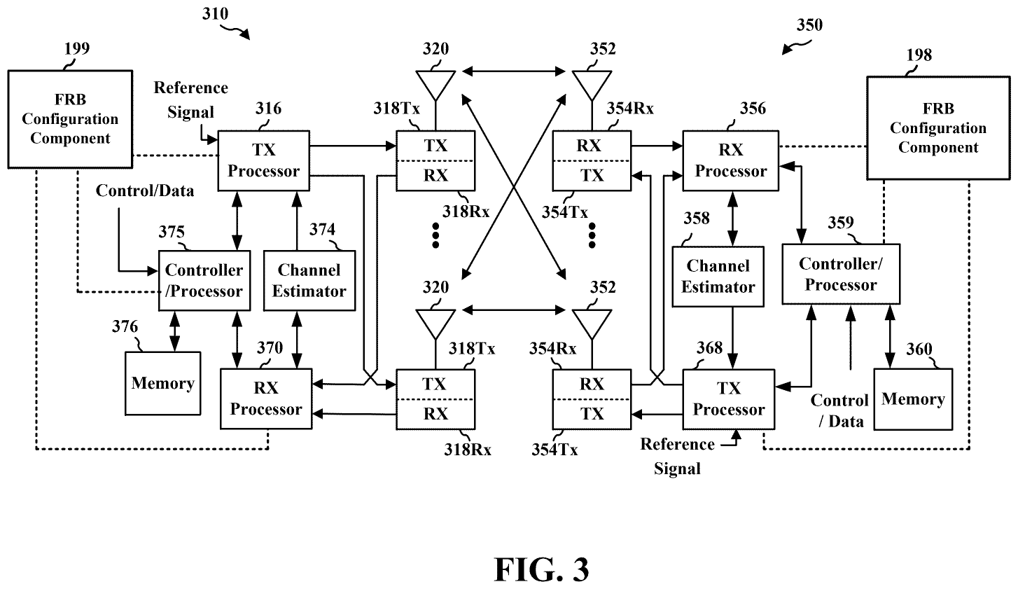

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the FRB configuration component 198 of FIG. 1.

At least one of the TX processor 316, the RX processor 370, and the controller/processor 375 may be configured to perform aspects in connection with the FRB configuration component 199 of FIG. 1.

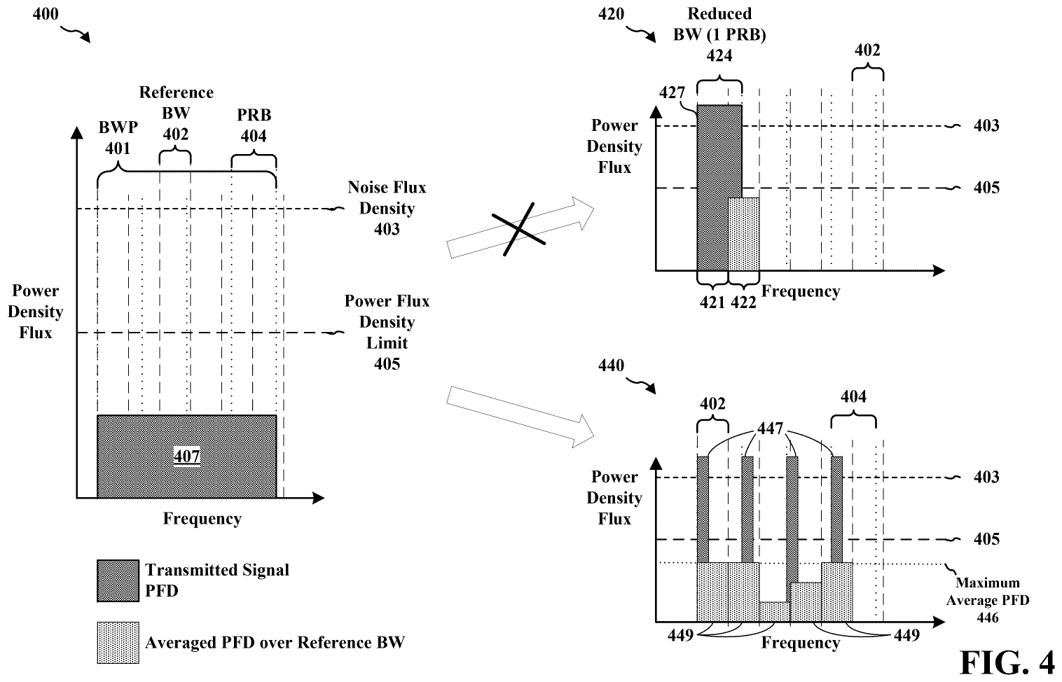

FIG. 4 is a set of diagrams (e.g., diagram 400, diagram 420, and diagram 440) illustrating aspects of signal transmission in the presence of an imposed PFD limit. Diagram 400 illustrates a BWP 401 associated with a signal transmitted at PFD 407, a noise density 403 (e.g., a power density associated with thermal, or other, sources of noise at a receiving device), and a PFD limit 405. It can be seen that the PFD limit 405, in some aspects, may be lower than the noise flux density such that the SNR based on the PFD 407 may be negative and/or below a SNR threshold associated with decoding the signal transmitted at the PFD 407 such that the signal transmitted at the PFD 407 may not be decodable at the receiving device. Diagram 400 further illustrates a reference bandwidth 402 associated with the PFD limit 405 and a PRB size 404 (where the BWP 401 for illustrative purposes includes and/or spans four PRBs with the understanding that a BWP may be configured to include other, larger, numbers of PRBs).

Diagram 420 illustrates a common solution to problems associated with power limitations that may not work for the PFD limit imposed as described above (e.g., the PFD limit imposed by the ITU for NTN communication). For example, a negative SNR based on a transmission power limit may be overcome by reducing a bandwidth (e.g., using a reduced bandwidth 424 that spans one PRB) to transmit the transmitted signal with a PFD 427 (e.g., a transmission power) such that the total transmission power is below the transmission power limit while, within the reduced bandwidth, the transmission power is greater than a power associated with noise such that a positive SNR is achieved. However, based on the small size (e.g., 1 MHZ) of the reference bandwidth 402 used to define the PFD limit for NTN transmissions compared to a single PRB size 404 within FR2 (e.g., typically 0.72 MHz or greater based on a sub-carrier spacing (SCS) of 60 kHz or more), this solution may still lead to exceeding the PFD in the reduced bandwidth 424. For example, when using a first PRB to transmit a signal with a PFD 427, while the average PFD over a second reference bandwidth 422 is below the PFD limit 405 (e.g., based on the transmission occupying a portion of the reference bandwidth) the average PFD over a first reference bandwidth 421 is equal to the PFD 427 which exceeds the PFD limit 405.

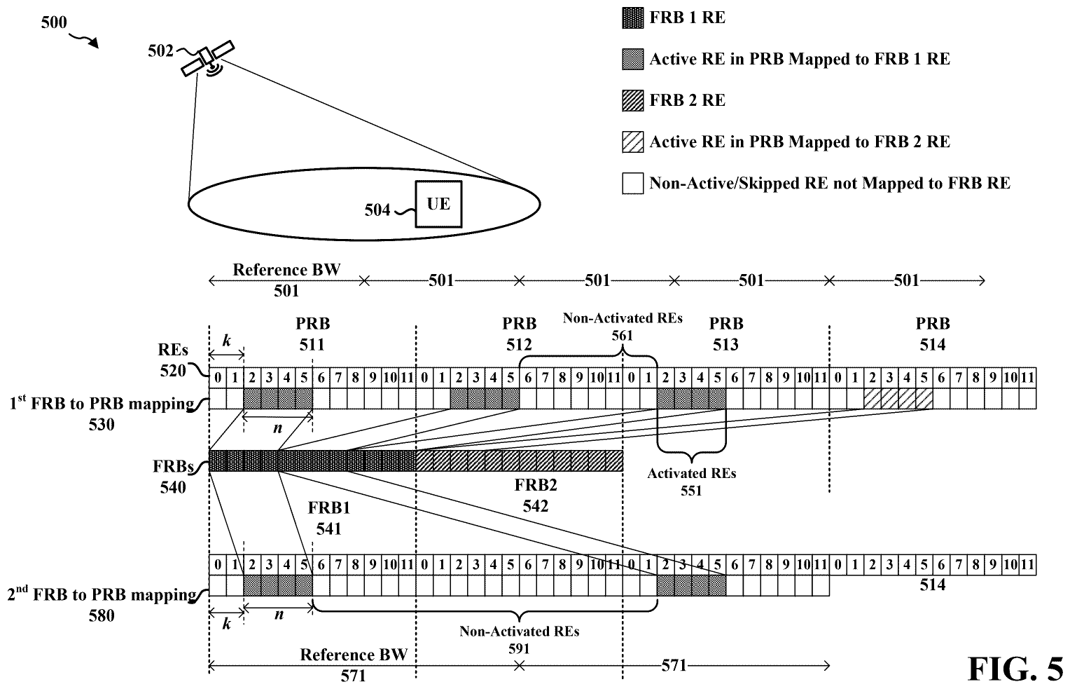

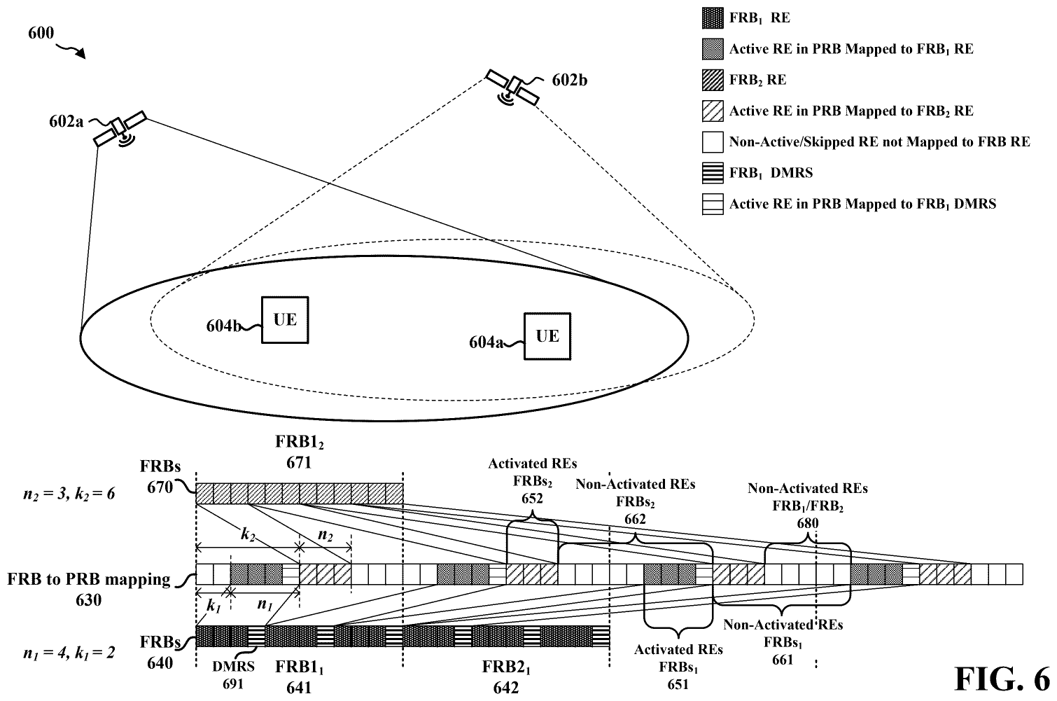

Diagram 440 illustrates using an interlace structure described in more detail in relation to FIGS. 5 and 6 below to cope with, or overcome, issues arising from the PFD limitation in FR2-NTN for handsets (e.g., wireless devices and/or UEs). For example, diagram 440 illustrates that by using a portion of each PRB (or a subset of the PRBs) within the BWP 401, the PFD 447 associated with the frequency resources used to transmit a signal may exceed the PFD associated with the noise (e.g., noise density 403) while maintaining an average PFD 449 (or a maximum average PFD 446) that does not exceed the PFD limit 405 in any reference bandwidth (e.g., the average PFD 449 is at or below the PFD limit 405 for all reference bandwidths associated with the transmitted signal).

FIG. 5 is a diagram 500 illustrating a configuration of a FRB (e.g., a FRB to PRB mapping 530) for communication between a network node 502 of a NTN and a wireless device (e.g., UE 504) in accordance with some aspects of the disclosure. In some aspects, a configuration for, or of, a FRB (e.g., a FRB configuration) may indicate a set of activated REs (e.g., the set of activated REs 551 in the set of REs 520) associated with the FRB configuration in each of a plurality of PRBs (e.g., including the PRB 511, the PRB 512, the PRB 513, and the PRB 514). The plurality of PRBs, in some aspects, may include a set of consecutive PRBs, e.g., if the PRB spans a frequency greater than the reference bandwidth and/or frequency range for a PFD threshold and/or limit (e.g., if the PRB size 404 is larger than the reference bandwidth 402 associated with PFD limit 405). If the PRB spans a frequency less than the reference bandwidth and/or frequency range for a PFD threshold and/or limit, the plurality of PRBs may include a set of non-consecutive, e.g., alternating activated and non-activated, PRBs, or a pair of adjacent PRBs may be considered and/or designated as the set of REs (e.g., a set of 28 REs) to which REs of the FRB may be mapped such that one or both PRBs in the pair of adjacent PRBs may include activated REs.

In some aspects, the FRB may include 12 REs (e.g., such that it matches the size of a PRB and can be processed using similar methods as a standard PRB). In some aspects, the FRB configuration may be based on at least a PFD limit for a reference frequency range. The reference frequency range, in some aspects, may be smaller than a frequency range spanned by one PRB. For example, the reference bandwidth 501 may be smaller than the range of frequencies spanned by a PRB (e.g. PRB 511).

For the FRB configuration illustrated in diagram 500, n is identified as, or indicated to be, equal to 4 and k is identified as, or indicated to be, equal to 2. In some aspects, the FRB configuration may be associated with a separate value indicated for each of the ‘variables’ n and k or both of the ‘variables’ n and k may be indicated by a single value (e.g., comparable to a start and length indicator value (SLIV) that indicates a start and length of PDSCH and/or PUSCH). The choice of n and k, in some aspects, may be based on a noise experienced at the receiving device (and reported to a network device and/or an associated NTN), the PFD limit, a reference bandwidth associated with the PFD limit, characteristics of the receiving device (e.g., an effective antenna area or Gᵣ), a frequency (or frequency range) associated with the FRB and/or transmitted signal, a SCS associated with the PRBs, a modulation and coding scheme (MCS) associated with the transmissions from the network node (e.g., that may be associated with a SNR threshold, an SCS, a data rate, etc.), an amount of data to be transmitted, a number of other configured FRBs associated with other network nodes of the NTN or other SSBs associated with the same network node. For example, the FRB configuration may be based on at least a PFD limit for a reference frequency range.

In some aspects, the set of activated REs may have a smaller frequency range than a reference bandwidth for a PFD threshold or limit (e.g., defined and/or imposed by the FCC or the ITU, such as in TU Radio Regulation Articles). For example, reference bandwidth 501 is larger than the frequency range spanned by the identified set of n activated REs in each of the plurality of PRBs. In some aspects, sets of activated REs (e.g., the set of activated REs 551) in adjacent PRBs in the set of consecutive PRBs may be separated by one or more REs (e.g., the set of non-activated REs 561) that are within the adjacent PRBs and are not used to transmit a signal associated with the FRB configured by the FRB configuration.

Diagram 500 illustrates that a first set of FRBs 540 including FRB1 541 and FRB2 542 associated with a same FRB configuration may be mapped to REs in a set of REs 520 in a plurality of PRBs including the PRB 511, the PRB 512, the PRB 513, and the PRB 514. The FRB configuration may indicate a value 4 for n and 2 for k such that the first four REs of FRB1 541 may be mapped to REs 2-5 of PRB 511, the second four REs of FRB1 541 may be mapped to REs 2-5 of PRB 512, the third/last four REs of FRB1 541 may be mapped to REs 2-5 of PRB 513, and the first four REs of FRB2 542 may be mapped to REs 2-5 of PRB 514.

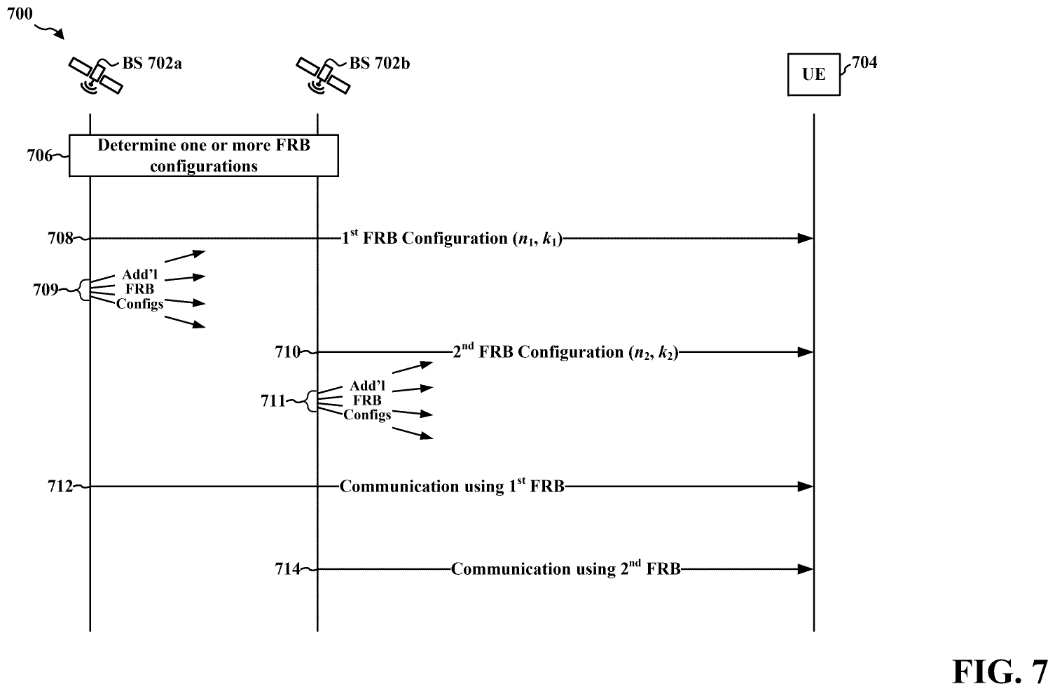

For a reference bandwidth 571 that is larger than a PRB (e.g., spans a larger frequency range than PRB 511), the FRB to PRB mapping 580 based on the same values of n and k, may consider the pair of PRBs including PRB 511 and PRB 512 to be a single unit for mapping the set of n activated REs and applying the offset k. In some aspects, one of the PRBs overlapping a reference bandwidth may be designated as a non-activated PRB such that no REs of an FRB are mapped to REs of the non-activated PRBs, where different FRB configurations as described below in relation to FIGS. 6 and 7 may designate different PRBs in a pair of PRBs as the non-activated PRB to avoid wasting resources. While this may lead to a sparser distribution of REs for a particular transmission, it may allow for a larger number of parallel transmissions (using a subset of the set of non-activated REs 591). Diagram 500 illustrates the case for a larger reference BW, but the same logic applies if the frequency range spanned by a PRB is reduced. For example, if the FRB to PRB mapping 530 is based on a SCS of 120 kHz and a reference bandwidth of 1 MHZ, the FRB to PRB mapping 580 may be based on the same reference bandwidth of 1 MHz and a SCS of 60 kHz. While illustrated as being associated with a same value for n and k, in some aspects, the value for n associated with the FRB to PRB mapping 580 may be increased (e.g., approximately doubled) such that the frequency range spanned by the REs of the PRB to which the REs of the FRB are mapped maximizes the number of REs and/or the spanned frequency range. For example, if a maximum of 4 REs may be transmitted for a SCS of 120 kHz at a first power based on a PFD limit (e.g., an associated PFD is given by PFD=α[4*120 kHz*P_{Tx}], where the PFD is assumed to be proportional to the frequency range multiplied by the power, and α[4*120 kHz*P_{Tx}]<PFDₗᵢₘᵢₜ<α[5*120 KHz*P_{Tx}]), a maximum of 8 or 9 REs may be transmitted for a SCS of 60 kHz at the first power (e.g., α[8*60 kHz*P_{Tx}]<PFDₗᵢₘᵢₜ<α[10*60 KHz*P_{Tx}]).

FIG. 6 is a diagram 600 illustrating a configuration of multiple (coordinated) FRBs (e.g., a FRB to PRB mapping 630 for multiple FRBs) for communication between multiple network nodes (e.g., network node 602a and network node 602b) of a same NTN and multiple wireless devices (e.g., UE 604a and UE 604b) in accordance with some aspects of the disclosure. In some aspects, a configuration for, or of, an FRB associated with each network node may be configured as described above in relation to FIG. 5. Diagram 600 further illustrates that the FRB configuration for a first set of FRBs 640 (including FRB11 641 and FRB21 642) associated with a first value of n and k (n₁ and k₁) and a second set of FRBs 670 (including FRB12 671) associated with a second value of n and k (n₂ and k₂) may be configured to be mapped to non-overlapping REs of the PRBs. For example, by selecting appropriate values of the variables n₁, k₁, n₂, and k₂, the REs associated with the first FRB configuration (e.g., the set of activated REs 651) and the REs associated with the second FRB configuration (e.g., the set of activated REs 652) may be disjoint. For example, the set of activated REs 652 for the second FRB configuration may fall within the set of non-activated REs 661 for the first FRB configuration and the set of activated REs 651 for the first FRB configuration may fall within the set of non-activated REs 662 for the second FRB configuration. Diagram 600 also indicates that a RE including a DMRS (e.g., DMRS 691) included in a FRB, e.g., FRB11 641 and FRB21 642, may be mapped to a RE in the PRBs in the same manner as the other REs of the FRBs. As illustrated in diagram 600, there may still be a set of non-activated REs 680 including the overlap between the set of non-activated REs 661 for the first FRB configuration and the set of non-activated REs 662 for the second FRB configuration, where the set of non-activated REs 680 are available for additional FRB configurations (e.g., associated with additional network nodes of the NTN (not shown) or with additional SSBs of the network nodes 602a and/or network node 602b). In some aspects, the set of non-activated REs 680 may also be available for network nodes of terrestrial networks (e.g., in coordination with the UEs and/or the NTN).

FIG. 7 is a call flow diagram 700 illustrating a method of wireless communication in accordance with some aspects of the disclosure. The method is illustrated in relation to a plurality of network nodes including network node 702a and network node 702b (e.g., as examples of a network device or network node that may include one or more components of a disaggregated base station) in communication with a UE 704 (e.g., as an example of a wireless device). In some aspects, the network node 702a and/or the network node 702b may be a satellite associated with a NTN. The functions ascribed to the network node 702a and/or the network node 702b, in some aspects, may be performed by one or more components of a network entity, a network node, or a network device (a single network entity/node/device or a disaggregated network entity/node/device as described above in relation to FIG. 1). Similarly, the functions ascribed to the UE 704, in some aspects, may be performed by one or more components of a wireless device supporting communication with a network entity/node/device. Accordingly, references to “transmitting” in the description below may be understood to refer to a first component of the network node 702a and/or the network node 702b (or the UE 704) outputting (or providing) an indication of the content of the transmission to be transmitted by a different component of the network node 702a and/or the network node 702b (or the UE 704). Similarly, references to “receiving” in the description below may be understood to refer to a first component of the network node 702a and/or the network node 702b (or the UE 704) receiving a transmitted signal and outputting (or providing) the received signal (or information based on the received signal) to a different component of the network node 702a and/or the network node 702b (or the UE 704).

At 706, the network node 702a and the network node 702b may determine and/or obtain one or more FRB configurations. The one or more FRB configurations, in some aspects, may include a first FRB configuration associated with the network node 702a and a second FRB configuration associated with the network node 702b. The one or more FRB configurations may be negotiated by the network node 702a and the network node 702b, may be autonomously determined by each of the network node 702a and the network node 702b (when independence and/or non-interference is assumed), or may be received from a network entity or device coordinating the FRB configurations among a plurality of network nodes associated with the NTN. In some aspects, the determination of the one or more FRB configurations may be based on at least a PFD limit for a reference frequency range or any of the other considerations discussed above in relation to FIG. 5. The reference frequency range, in some aspects, may be smaller than a frequency range spanned by one PRB.

Based on the determination at 706, the network node 702a may transmit, and the UE 704 may receive (or obtain), a first FRB configuration 708 (e.g., an FRB configuration as described in relation to FIGS. 5 and 6). In some aspects, the first FRB configuration 708 may be associated with a particular SSB and may be received via a SIB associated with (or included in) the SSB. The first FRB configuration 708 may be used for subsequent communications associated with the particular SSB. In some aspects, different SSBs from a same network node, e.g., SSBs associated with a set of additional FRB configurations 709, different FRB configurations in the set of additional FRB configurations 709 may indicate the same and/or different values for n and/or k. For example, different SSBs may be associated with different angles of arrival (or expected angles of arrival) at a UE that may have different PFDs applied (where the PFD depends on, for example, an angle above a horizontal direction) such that different values for n and k may be selected to maximize throughput for different SSBs. Similarly, different SSBs may be associated with different beam widths and transmissions associated with the different SSBs may be able to use different numbers of REs per PRB (a different value for n) while maintaining a PFD below a PFD limit such that different values for n and k may be selected to maximize throughput for the different SSBs.

The first FRB configuration 708, in some aspects, may be for a first FRB including a first set of activated REs associated with the FRB configuration in each of a first plurality of PRBs. A FRB, in some aspects, may include 12 REs. In some aspects, the first plurality of PRBs may include a set of consecutive PRBs. The first set of activated REs, in some aspects, may have a smaller frequency range than a reference bandwidth for a PFD threshold and/or limit associated with a communication between the network node 702a and the UE 704. In some aspects, sets of activated REs in adjacent PRBs in the set of consecutive PRBs may be separated by one or more REs that are within the adjacent PRBs and are not used to transmit a signal associated with the first FRB configured by the first FRB configuration (e.g., the set of non-activated REs 561 or 661 of FIG. 5 or 6, respectively). The first FRB configuration, in some aspects, may identify, or indicate, a first number, n₁, of the activated REs in the first set of activated REs in each of the first plurality of PRBs and/or a first offset value, k₁, indicating a second number of REs from a first RE of each of the first plurality of PRBs at which the first set of activated REs begins. In some aspects, the first FRB configuration 708 may apply to a DMRS associated with the FRB, e.g., the DMRS included in the FRB may be mapped to the set of activated REs in each of the plurality of PRBs based on the same mapping as used for REs of the FRB not including a DMRS (as illustrated in FIG. 6).

Based on the determination at 706, the network node 702b may transmit, and the UE 704 may receive (or obtain), a second FRB configuration 710 (e.g., an FRB configuration as described in relation to FIGS. 5 and/or 6). In some aspects, the second FRB configuration 710 may be associated with a particular SSB and may be received via a SIB associated with (or included in) the SSB. The second FRB configuration 710 may be used for subsequent communications associated with the particular SSB. In some aspects, different SSBs from a same network node, e.g., SSBs associated with a set of additional FRB configurations 711, different FRB configurations in the set of additional FRB configurations 711 may indicate the same and/or different values for n and/or k. For example, different SSBs may be associated with different angles of arrival (or expected angles of arrival) at a UE that may have different PFDs applied (where the PFD depends on, for example, an angle above a horizontal direction) such that different values for n and k may be selected to maximize throughput for different SSBs. Similarly, different SSBs may be associated with different beam widths and transmissions associated with the different SSBs may be able to use different numbers of REs per PRB (a different value for n) while maintaining a PFD below a PFD limit such that different values for n and k may be selected to maximize throughput for the different SSBs.

The second FRB configuration 710, in some aspects, may be for a second FRB including a second set of activated REs associated with the FRB configuration in each of a second plurality of PRBs. A FRB, in some aspects, may include 12 REs. In some aspects, the second plurality of PRBs may include a set of consecutive PRBs. The second set of activated REs, in some aspects, may have a smaller frequency range than a reference bandwidth for a second PFD threshold and/or limit associated with a communication between the network node 702b and the UE 704, where the second PFD limit may be different or the same as the PFD limit associated with the communication between the network node 702a and the UE 704 based on different characteristics of the communications (e.g., frequency ranges, angles of arrival, etc.). In some aspects, sets of activated REs in adjacent PRBs in the set of consecutive PRBs may be separated by one or more REs that are within the adjacent PRBs and are not used to transmit a signal associated with the second FRB configured by the second FRB configuration (e.g., the set of non-activated REs 662 of FIG. 6). The second FRB configuration, in some aspects, may identify, or indicate, a second number, n₂, of the activated REs in the second set of activated REs in each of the second plurality of PRBs and/or a second offset value, k₂, indicating a second number of REs from a first RE of each of the second plurality of PRBs at which the second set of activated REs begins. In some aspects, the second FRB configuration 710 may apply to a DMRS associated with the FRB, e.g., the DMRS included in the FRB may be mapped to the set of activated REs in each of the plurality of PRBs based on the same mapping as used for REs of the FRB not including a DMRS.

Based on the first FRB configuration 708, the network node 702a may transmit, and the UE 704 may receive, transmission 712 using, or based on, the first FRB configuration. In some aspects, the transmission 712 may be received in the first number of the activated REs with a PFD that is greater than the PFD limit for the reference frequency range based on the first number of the activated REs spanning less than the reference frequency range such that the PFD averaged over the reference frequency range is lower than the PFD limit for the reference frequency range. In some aspects, the transmission 712 may include a DMRS associated with the FRB mapped to the first set of activated REs in each of the first plurality of PRBs. In some aspects, receiving the transmission includes receiving the transmission from a NTN node (e.g., the network node 702a) via the at least one FRB (e.g., the first FRB or at least one FRB associated with the first FRB configuration 708).

Based on the second FRB configuration 710, the network node 702b may transmit, and the UE 704 may receive, an additional transmission 714 using the second FRB configuration. In some aspects, the additional transmission 714 may be received in the second number of the activated REs with a PFD that is greater than the PFD limit for the reference frequency range based on the second number of the activated REs spanning less than the reference frequency range such that the PFD averaged over the reference frequency range is lower than the PFD limit for the reference frequency range. In some aspects, the additional transmission 714 may include a DMRS associated with the FRB(s) mapped to the second set of activated REs in each of the second plurality of PRBs. In some aspects, receiving the transmission includes receiving the additional transmission from a NTN node (e.g., the network node 702b) via the at least one additional FRB associated with the second FRB configuration 710. While discussed in relation to two network nodes of a NTN, the method above may apply to three or more network nodes such that three or more FRB configurations may be obtained and/or received by a UE to facilitate communication with each of the three or more network nodes. Additionally, while the above discussion assumes a single UE (e.g., UE 704) in communication with both network node 702a and network node 702b, in some aspects, multiple UEs may be in communication with each network node and a UE in communication with a particular network node may not be in communication with other network nodes. For example, a first UE (or a first set of UEs) may receive the first FRB configuration 708 and the transmission 712 based on the first FRB configuration 708, while a second UE (or second set of UEs) may receive the second FRB configuration 710 and the additional transmission 714 based on the second FRB configuration 710.

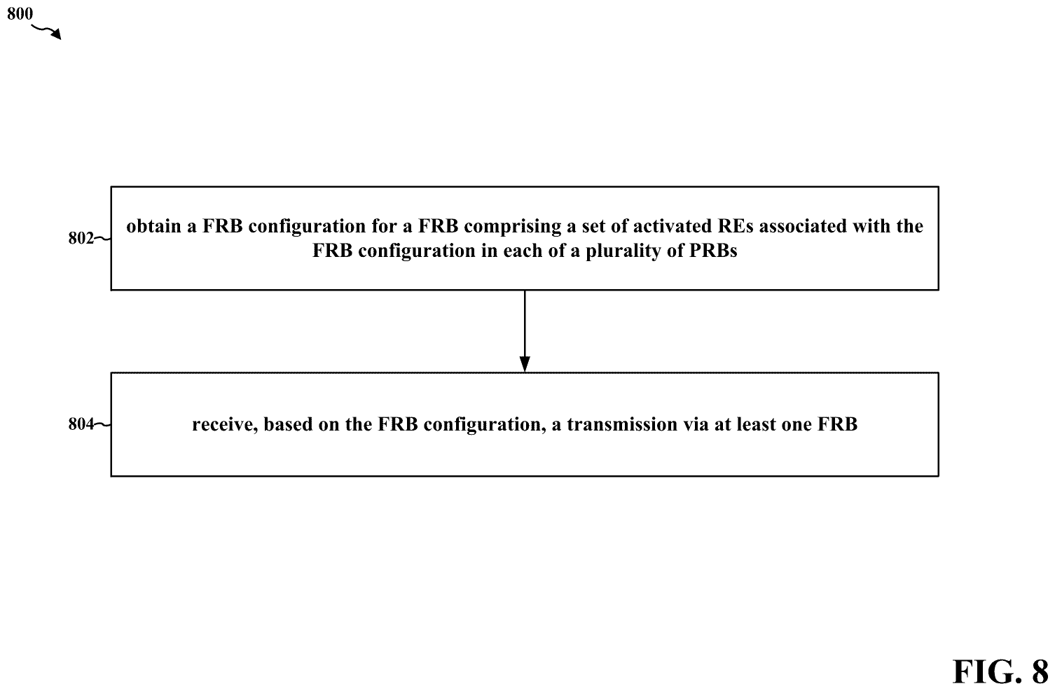

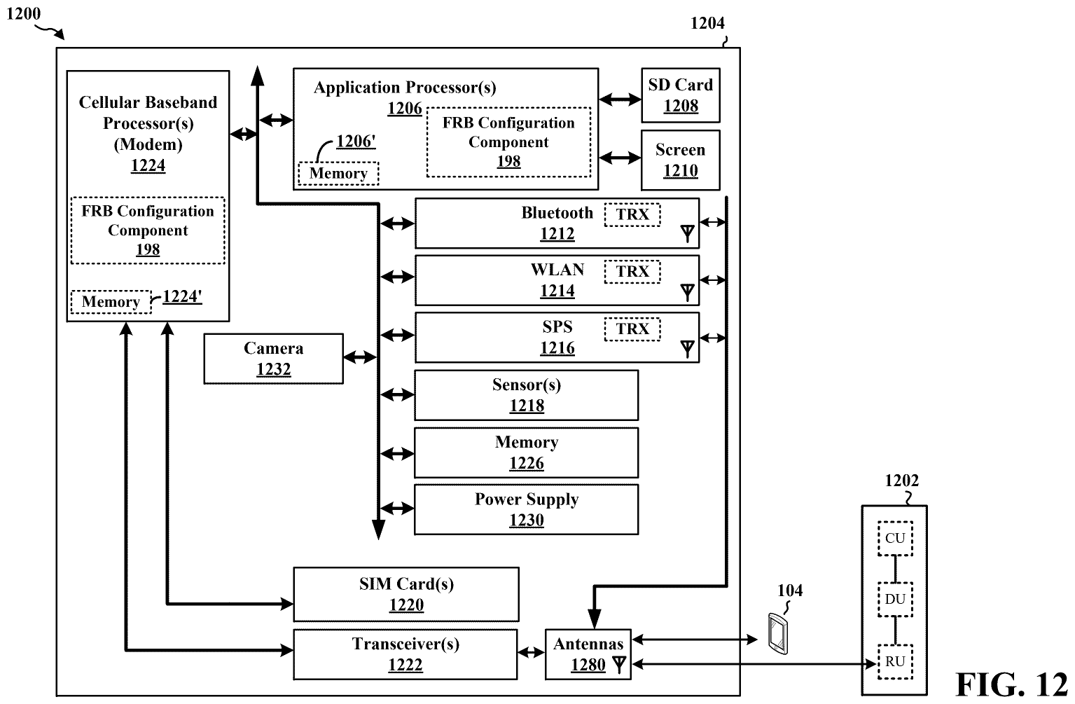

FIG. 8 is a flowchart 800 of a method of wireless communication. The method may be performed by a UE (e.g., the UE 104, 504, 604a, 604b, 704; the apparatus 1204). At 802, the UE may obtain a FRB configuration for a FRB including a set of activated REs associated with the FRB configuration in each of a plurality of PRBs. For example, 802 may be performed by application processor(s) 1206, cellular baseband processor(s) 1224, transceiver(s) 1222, antenna(s) 1280, and/or FRB configuration component 198 of FIG. 12. In some aspects, the FRB configuration may be associated with a particular SSB and may be received via a SIB associated with (or included in) the SSB. The FRB configuration may be used for subsequent communications associated with the particular SSB. In some aspects, different SSBs may include and/or indicate different FRB configurations or a same FRB configuration as described in relation to the FRB configurations of FIG. 7.

The FRB configuration, in some aspects, may be for a FRB including a set of activated REs associated with the FRB configuration in each of a plurality of PRBs. A FRB, in some aspects, may include 12 REs. In some aspects, the plurality of PRBs may include a set of consecutive PRBs. The set of activated REs, in some aspects, may have a smaller frequency range than a reference bandwidth for a PFD threshold and/or limit associated with a communication between a network node and the UE. In some aspects, sets of activated REs in adjacent PRBs in the set of consecutive PRBs may be separated by one or more REs that are within the adjacent PRBs and are not used to transmit a signal associated with the FRB configured by the FRB configuration (e.g., the set of non-activated REs 561 or 661 of FIG. 5 or 6, respectively). The FRB configuration, in some aspects, may identify, or indicate, a first number, n₁, of the activated REs in the set of activated REs in each of the plurality of PRBs and/or an offset value, k₁, indicating a second number of REs from a first RE of each of the plurality of PRBs at which the set of activated REs begins. In some aspects, the FRB configuration may apply to a DMRS associated with the FRB, e.g., the DMRS included in the FRB may be mapped to the set of activated REs in each of the plurality of PRBs based on the same mapping as used for REs of the FRB not including a DMRS (as illustrated in FIG. 6). For example, referring to FIGS. 5-7, the UE 704 may receive the first FRB configuration 708 indicating a FRB configuration as described in relation to any of FIGS. 5-7.

At 804, the UE may receive, based on the FRB configuration, a transmission via at least one FRB. For example, 804 may be performed by application processor(s) 1206, cellular baseband processor(s) 1224, transceiver(s) 1222, antenna(s) 1280, and/or FRB configuration component 198 of FIG. 12. In some aspects, the transmission may be received in the first number of the activated REs with a PFD that is greater than the PFD limit for the reference frequency range based on the first number of the activated REs spanning less than the reference frequency range such that the PFD averaged over the reference frequency range is lower than the PFD limit for the reference frequency range. The reference frequency range, in some aspects, may be smaller than a frequency range spanned by one PRB. In some aspects, the transmission may include a DMRS associated with the FRB mapped to the set of activated REs in each of the plurality of PRBs. In some aspects, receiving the transmission includes receiving the transmission from a NTN node via the at least one FRB (e.g., the first FRB). For example, referring to FIG. 7, the UE 704 may receive the transmission 712 using the first FRB configuration 708.

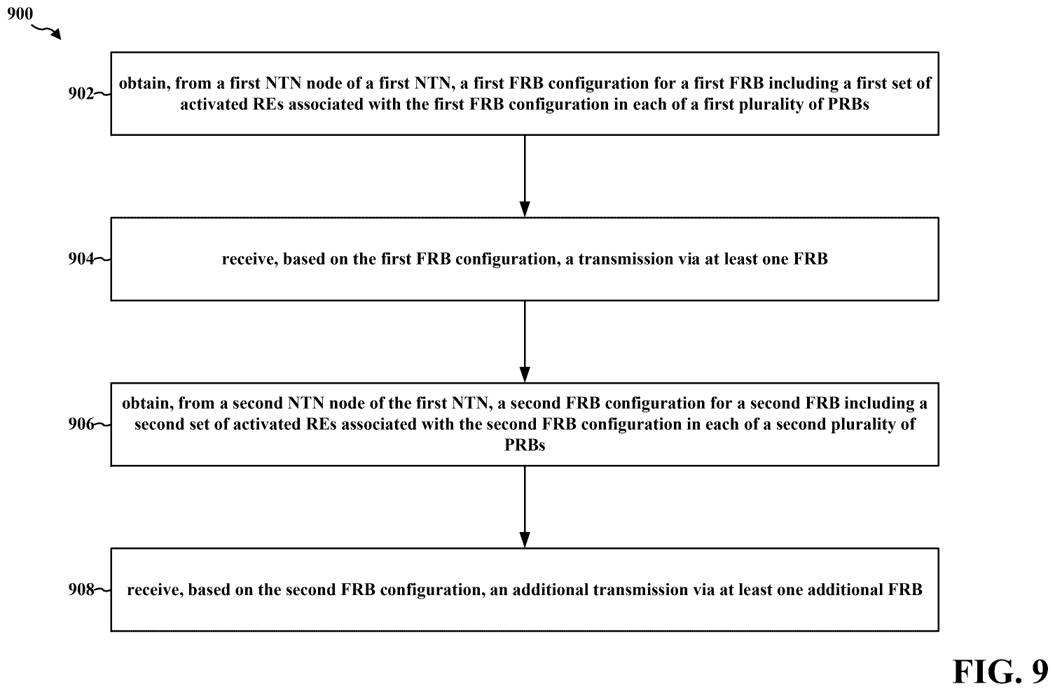

FIG. 9 is a flowchart 900 of a method of wireless communication. The method may be performed by a UE (e.g., the UE 104, 504, 604a, 604b, 704; the apparatus 1204). At 902, the UE may obtain, from a first NTN node of a first NTN, a first FRB configuration for a first FRB including a first set of activated REs associated with the first FRB configuration in each of a first plurality of PRBs. For example, 902 may be performed by application processor(s) 1206, cellular baseband processor(s) 1224, transceiver(s) 1222, antenna(s) 1280, and/or FRB configuration component 198 of FIG. 12. In some aspects, the first FRB configuration may be associated with a particular SSB and may be received via a SIB associated with (or included in) the SSB. The first FRB configuration may be used for subsequent communications associated with the particular SSB. In some aspects, different SSBs may include and/or indicate different FRB configurations or a same FRB configuration as described in relation to the FRB configurations of FIG. 7.

The first FRB configuration, in some aspects, may be for a first FRB including a first set of activated REs associated with the FRB configuration in each of a first plurality of PRBs. The first FRB, in some aspects, may include 12 REs. In some aspects, the first plurality of PRBs may include a set of consecutive PRBs. The first set of activated REs, in some aspects, may have a smaller frequency range than a reference bandwidth for a PFD threshold and/or limit associated with a communication between a network node and the UE. In some aspects, sets of activated REs in adjacent PRBs in the set of consecutive PRBs may be separated by one or more REs that are within the adjacent PRBs and are not used to transmit a signal associated with the first FRB configured by the first FRB configuration (e.g., the set of non-activated REs 561 or 661 of FIG. 5 or 6, respectively). The first FRB configuration, in some aspects, may identify, or indicate, a first number, n₁, of the activated REs in the first set of activated REs in each of the first plurality of PRBs and/or a first offset value, k₁, indicating a second number of REs from a first RE of each of the first plurality of PRBs at which the first set of activated REs begins. In some aspects, the first FRB configuration may apply to a DMRS associated with the FRB, e.g., the DMRS included in the FRB may be mapped to the set of activated REs in each of the plurality of PRBs based on the same mapping as used for REs of the FRB not including a DMRS (as illustrated in FIG. 6).

For example, referring to FIGS. 5-7, the UE 704 may receive first FRB configuration 708 indicating a first FRB configuration as described in relation to any of FIGS. 5-7. At 904, the UE may receive, based on the first FRB configuration, a transmission via at least one FRB. For example, 904 may be performed by application processor(s) 1206, cellular baseband processor(s) 1224, transceiver(s) 1222, antenna(s) 1280, and/or FRB configuration component 198 of FIG. 12. In some aspects, the transmission may be received in the first number of the activated REs with a PFD that is greater than the PFD limit for the reference frequency range based on the first number of the activated REs spanning less than the reference frequency range such that the PFD averaged over the reference frequency range is lower than the PFD limit for the reference frequency range. The reference frequency range, in some aspects, may be smaller than a frequency range spanned by one PRB. In some aspects, the transmission may include a DMRS associated with the FRB(s) mapped to the first set of activated REs in each of the first plurality of PRBs. In some aspects, receiving the transmission includes receiving the transmission from a NTN node via the at least one FRB (e.g., the first FRB). For example, referring to FIG. 7, the UE 704 may receive the transmission 712 using the first FRB configuration 708.

At 906, the UE may obtain, from a second NTN node of the first NTN, a second FRB configuration for a second FRB including a second set of activated REs associated with the second FRB configuration in each of a second plurality of PRBs. For example, 906 may be performed by application processor(s) 1206, cellular baseband processor(s) 1224, transceiver(s) 1222, antenna(s) 1280, and/or FRB configuration component 198 of FIG. 12. In some aspects, the second FRB configuration may be associated with a particular SSB and may be received via a SIB associated with (or included in) the SSB. The second FRB configuration may be used for subsequent communications associated with the particular SSB. In some aspects, different SSBs may include and/or indicate different FRB configurations or a same FRB configuration as described in relation to the FRB configurations of FIG. 7.

The second FRB configuration, in some aspects, may be for a second FRB including a second set of activated REs associated with the FRB configuration in each of a second plurality of PRBs. The second FRB, in some aspects, may include 12 REs. In some aspects, the second plurality of PRBs may include a set of consecutive PRBs. The second set of activated REs, in some aspects, may have a smaller frequency range than a reference bandwidth for a second PFD threshold and/or limit associated with a communication between a second network node and the UE, where the second PFD limit may be different or the same as the PFD limit associated with the communication between the second network node and the UE based on different characteristics of the communications (e.g., frequency ranges, angles of arrival, etc.). In some aspects, sets of activated REs in adjacent PRBs in the set of consecutive PRBs may be separated by one or more REs that are within the adjacent PRBs and are not used to transmit a signal associated with the second FRB configured by the second FRB configuration (e.g., the set of non-activated REs 662 of FIG. 6). The second FRB configuration, in some aspects, may identify, or indicate, a second number, n₂, of the activated REs in the second set of activated REs in each of the second plurality of PRBs and/or an offset value, k₂, indicating a second number of REs from a first RE of each of the second plurality of PRBs at which the second set of activated REs begins. The first and second plurality of PRBs, in some aspects, may include at least one common PRB and the second set of activated REs may be disjoint from the first set of activated REs within the at least one common PRB. In some aspects, the second FRB configuration may apply to a DMRS associated with the FRB, e.g., the DMRS included in the FRB may be mapped to the set of activated REs in each of the plurality of PRBs based on the same mapping as used for REs of the FRB not including a DMRS. For example, referring to FIGS. 5-7, the UE 704 may receive second FRB configuration 710 indicating a second FRB configuration as described in relation to any of FIGS. 5-7.

At 908, the UE may receive, based on the second FRB configuration, an additional transmission via at least one additional FRB. For example, 904 may be performed by application processor(s) 1206, cellular baseband processor(s) 1224, transceiver(s) 1222, antenna(s) 1280, and/or FRB configuration component 198 of FIG. 12. In some aspects, the transmission may be received in the second number of the activated REs with a PFD that is greater than the PFD limit for the reference frequency range based on the second number of the activated REs spanning less than the reference frequency range such that the PFD averaged over the reference frequency range is lower than the PFD limit for the reference frequency range. The reference frequency range, in some aspects, may be smaller than a frequency range spanned by one PRB. In some aspects, the transmission may include a DMRS associated with the FRB(s) mapped to the second set of activated REs in each of the second plurality of PRBs. In some aspects, receiving the transmission includes receiving the additional transmission from a NTN node via the at least one additional FRB associated with the second FRB configuration. For example, referring to FIG. 7, the UE 704 may receive the additional transmission 714 using the second FRB configuration 710.

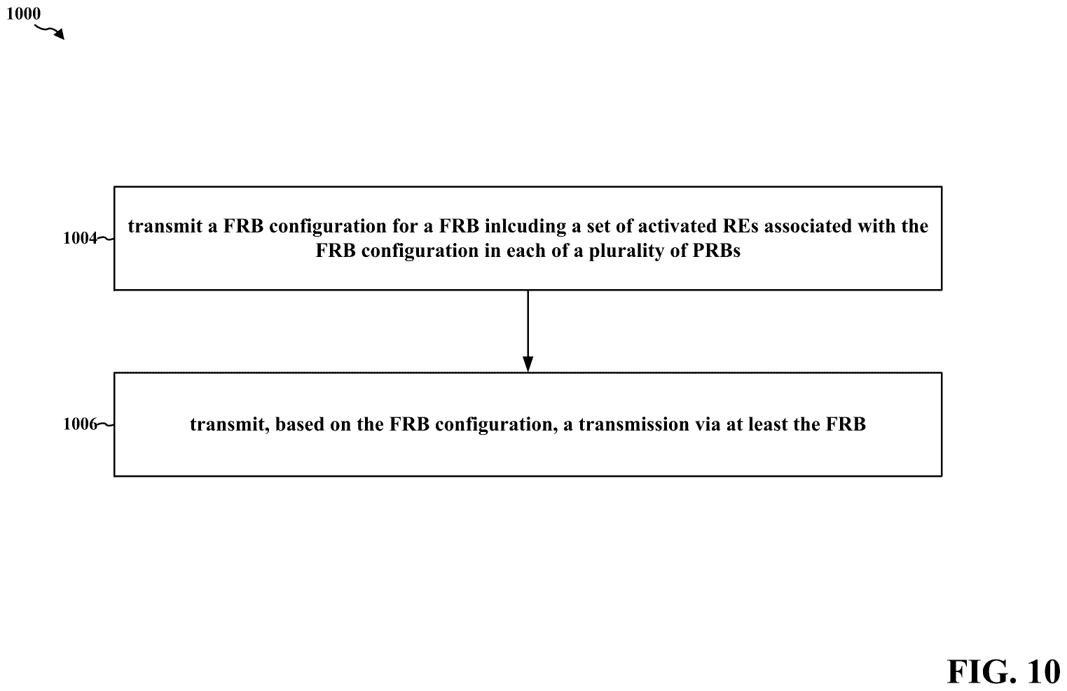

FIG. 10 is a flowchart 1000 of a method of wireless communication. The method may be performed by a network node (e.g., the base station 102; the network node 502, 602a, 602b, 702a, 702b; the network entity 1202, 1302, 1460). In some aspects, the network node may obtain a FRB configuration for a FRB including a set of activated REs associated with the FRB configuration in each of a plurality of PRBs. In some aspects, obtaining the FRB configuration may be based on one of negotiating with one or more additional network nodes of a same and/or common NTN, an autonomous determination by the network node (when independence from, and/or non-interference with, other network nodes of the same and/or common NTN is assumed), or may be received from a network entity or device coordinating the FRB configurations among a plurality of network nodes associated with the NTN. For example, referring to FIG. 7, the network node 702a may, at 706, determine and/or obtain at least one FRB configuration.

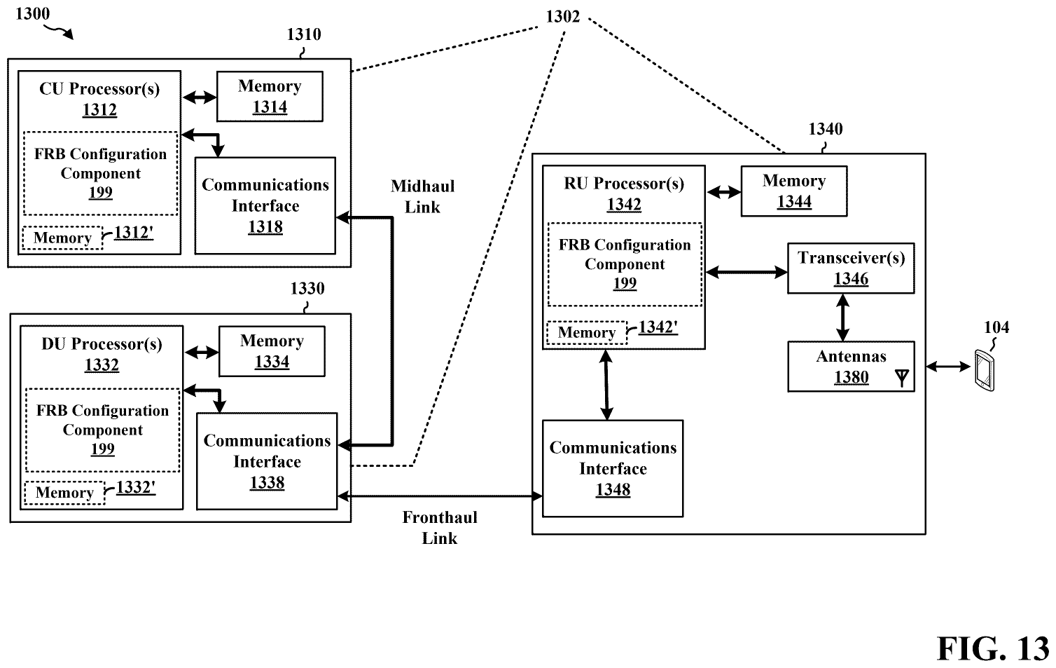

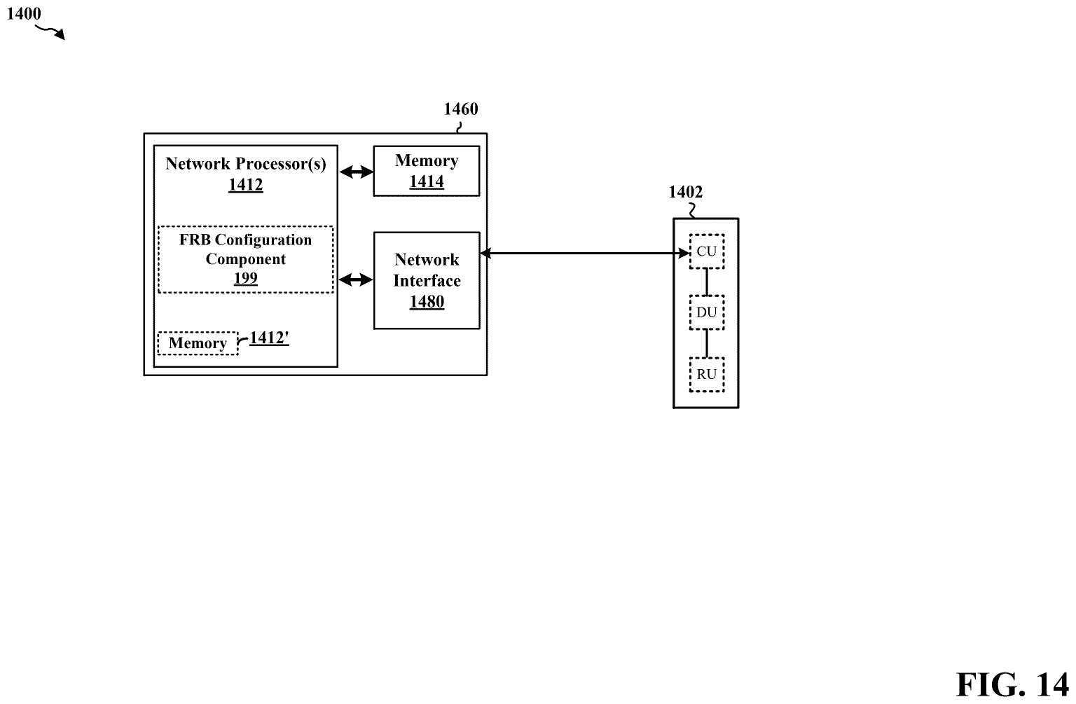

At 1004, the network node may transmit a FRB configuration for a FRB including a set of activated REs associated with the FRB configuration in each of a plurality of PRBs. For example, 1004 may be performed by CU processor(s) 1312, DU processor(s) 1332, RU processor(s) 1342, transceiver(s) 1346, antenna(s) 1380, network processor 1412, network interface 1480, and/or FRB configuration component 199 of FIGS. 13 and 14. In some aspects, the FRB configuration may be associated with a particular SSB and may be transmitted via a SIB associated with (or included in) the SSB. The FRB configuration may be used for subsequent communications associated with the particular SSB. In some aspects, different SSBs may include and/or indicate different FRB configurations or a same FRB configuration as described in relation to the first FRB configuration 708 and the set of additional FRB configurations 709 of FIG. 7.

The FRB configuration, in some aspects, may be for a FRB including a set of activated REs associated with the FRB configuration in each of a plurality of PRBs. A FRB, in some aspects, may include 12 REs. In some aspects, the plurality of PRBs may include a set of consecutive PRBs. The set of activated REs, in some aspects, may have a smaller frequency range than a reference bandwidth for a PFD threshold and/or limit associated with a communication between a network node and the UE. In some aspects, sets of activated REs in adjacent PRBs in the set of consecutive PRBs may be separated by one or more REs that are within the adjacent PRBs and are not used to transmit a signal associated with the FRB configured by the FRB configuration (e.g., the set of non-activated REs 561 or 661 of FIG. 5 or 6, respectively). The FRB configuration, in some aspects, may identify, or indicate, a first number, n₁, of the activated REs in the set of activated REs in each of the plurality of PRBs and/or an offset value, k₁, indicating a second number of REs from a first RE of each of the plurality of PRBs at which the set of activated REs begins. In some aspects, the FRB configuration may apply to a DMRS associated with the FRB, e.g., the DMRS included in the FRB may be mapped to the set of activated REs in each of the plurality of PRBs based on the same mapping as used for REs of the FRB not including a DMRS (as illustrated in FIG. 6). For example, referring to FIGS. 5-7, the network node 702a may transmit, and the UE 704 may receive, the first FRB configuration 708 indicating a FRB configuration as described in relation to any of FIGS. 5-7.

At 1006, the network node may transmit, based on the FRB configuration, a transmission via at least the FRB. For example, 1006 may be performed by CU processor(s) 1312, DU processor(s) 1332, RU processor(s) 1342, transceiver(s) 1346, antenna(s) 1380, network processor 1412, network interface 1480, and/or FRB configuration component 199 of FIGS. 13 and 14. In some aspects, transmitting the transmission at 1006 may include increasing a power density of the transmission within the set of activated REs above the PFD threshold based on the set of activated REs having the smaller frequency range than the reference bandwidth for the PFD threshold. Increasing the power density of the transmission within the set of activated REs above the PFD threshold, in some aspects, may refer to increasing a power associated with the transmission within the set of activated REs such that the PFD within the set of activated resources as measured on Earth is greater than the PFD limit, but the average PFD over a reference frequency range or bandwidth is within, or less than, the PFD limit (e.g., as described in relation to diagram 440 of FIG. 4). The reference frequency range, in some aspects, may be smaller than a frequency range spanned by one PRB. In some aspects, the transmission may include a DMRS associated with the FRB mapped to the set of activated REs in each of the plurality of PRBs. In some aspects, receiving the transmission includes receiving the transmission from a NTN node via the at least one FRB (e.g., the first FRB). For example, referring to FIG. 7, the network node 702a may transmit, and the UE 704 may receive, the transmission 712 using the first FRB configuration 708.

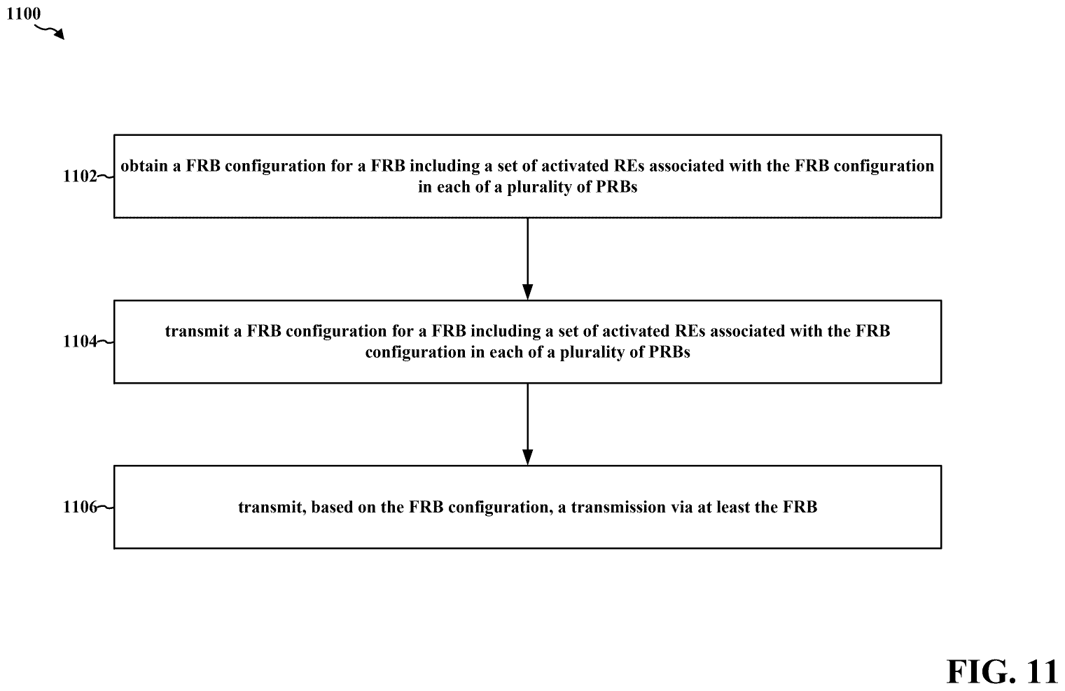

FIG. 11 is a flowchart 1100 of a method of wireless communication. The method may be performed by a network node (e.g., the base station 102; the network node 502, 602a, 602b, 702a, 702b; the network entity 1202, 1302, 1460). At 1102, the network node may obtain a FRB configuration for a FRB including a set of activated REs associated with the FRB configuration in each of a plurality of PRBs. For example, 1102 may be performed by CU processor(s) 1312, DU processor(s) 1332, RU processor(s) 1342, transceiver(s) 1346, antenna(s) 1380, network processor 1412, network interface 1480, and/or FRB configuration component 199 of FIGS. 13 and 14. In some aspects, obtaining the FRB configuration may be based on one of negotiating with one or more additional network nodes of a same and/or common NTN, an autonomous determination by the network node (when independence from, and/or non-interference with, other network nodes of the same and/or common NTN is assumed), or may be received from a network entity or device coordinating the FRB configurations among a plurality of network nodes associated with the NTN. For example, referring to FIG. 7, the network node 702a may, at 706, determine and/or obtain at least one FRB configuration.

At 1104, the network node may transmit a FRB configuration for a FRB including a set of activated REs associated with the FRB configuration in each of a plurality of PRBs. For example, 1104 may be performed by CU processor(s) 1312, DU processor(s) 1332, RU processor(s) 1342, transceiver(s) 1346, antenna(s) 1380, network processor 1412, network interface 1480, and/or FRB configuration component 199 of FIGS. 13 and 14. In some aspects, the FRB configuration may be associated with a particular SSB and may be transmitted via a SIB associated with (or included in) the SSB. The FRB configuration may be used for subsequent communications associated with the particular SSB. In some aspects, different SSBs may include and/or indicate different FRB configurations or a same FRB configuration as described in relation to the first FRB configuration 708 and the set of additional FRB configurations 709 of FIG. 7.

The FRB configuration, in some aspects, may be for a FRB including a set of activated REs associated with the FRB configuration in each of a plurality of PRBs. A FRB, in some aspects, may include 12 REs. In some aspects, the plurality of PRBs may include a set of consecutive PRBs. The set of activated REs, in some aspects, may have a smaller frequency range than a reference bandwidth for a PFD threshold and/or limit associated with a communication between a network node and the UE. In some aspects, sets of activated REs in adjacent PRBs in the set of consecutive PRBs may be separated by one or more REs that are within the adjacent PRBs and are not used to transmit a signal associated with the FRB configured by the FRB configuration (e.g., the set of non-activated REs 561 or 661 of FIG. 5 or 6, respectively). The FRB configuration, in some aspects, may identify, or indicate, a first number, n₁, of the activated REs in the set of activated REs in each of the plurality of PRBs and/or an offset value, k₁, indicating a second number of REs from a first RE of each of the plurality of PRBs at which the set of activated REs begins. In some aspects, the FRB configuration may apply to a DMRS associated with the FRB, e.g., the DMRS included in the FRB may be mapped to the set of activated REs in each of the plurality of PRBs based on the same mapping as used for REs of the FRB not including a DMRS (as illustrated in FIG. 6). For example, referring to FIGS. 5-7, the network node 702a may transmit, and the UE 704 may receive, the first FRB configuration 708 indicating a FRB configuration as described in relation to any of FIGS. 5-7.

At 1106, the network node may transmit, based on the FRB configuration, a transmission via at least the FRB. For example, 1106 may be performed by CU processor(s) 1312, DU processor(s) 1332, RU processor(s) 1342, transceiver(s) 1346, antenna(s) 1380, network processor 1412, network interface 1480, and/or FRB configuration component 199 of FIGS. 13 and 14. In some aspects, transmitting the transmission at 1106 may include increasing a power density of the transmission within the set of activated REs above the PFD threshold based on the set of activated REs having the smaller frequency range than the reference bandwidth for the PFD threshold. Increasing the power density of the transmission within the set of activated REs above the PFD threshold, in some aspects, may refer to increasing a power associated with the transmission within the set of activated REs such that the PFD within the set of activated resources as measured on Earth is greater than the PFD limit, but the average PFD over a reference frequency range or bandwidth is within, or less than, the PFD limit (e.g., as described in relation to diagram 440 of FIG. 4). The reference frequency range, in some aspects, may be smaller than a frequency range spanned by one PRB. In some aspects, the transmission may include a DMRS associated with the FRB mapped to the set of activated REs in each of the plurality of PRBs. In some aspects, receiving the transmission includes receiving the transmission from a NTN node via the at least one FRB (e.g., the first FRB). For example, referring to FIG. 7, the network node 702a may transmit, and the UE 704 may receive, the transmission 712 using the first FRB configuration 708.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize one or more antennas 1280 for communication. The cellular baseband processor(s) 1224 communicates through the transceiver(s) 1222 via the one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the FRB configuration component 198 may be configured to obtain a FRB configuration for a FRB comprising a set of activated REs associated with the FRB configuration in each of a plurality of PRBs and receive, based on the FRB configuration, a transmission via at least one FRB. The FRB configuration component 198 may be within the cellular baseband processor(s) 1224, the application processor(s) 1206, or both the cellular baseband processor(s) 1224 and the application processor(s) 1206. The FRB configuration component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for obtaining a flexible resource block (FRB) configuration for a FRB comprising a set of activated resource elements (REs) associated with the FRB configuration in each of a plurality of physical resource blocks (PRBs). The apparatus 1204, and in particular the cellular baseband processor(s) 1224 and/or the application processor(s) 1206, may include means for receiving, based on the FRB configuration, a transmission via at least one FRB. The apparatus 1204, and in particular the cellular baseband processor(s) 1224 and/or the application processor(s) 1206, may include means for obtaining, from a second NTN node of the first NTN, a second FRB configuration for a second FRB comprising a second set of activated REs associated with the second FRB configuration in each of a second plurality of PRBs, wherein the first and second plurality of PRBs comprise at least one common PRB and the second set of activated REs is disjoint from the first set of activated REs within the at least one common PRB. The apparatus 1204, and in particular the cellular baseband processor(s) 1224 and/or the application processor(s) 1206, may include means for receiving, based on the second FRB configuration, an additional transmission via at least one additional FRB. The apparatus 1204 may further include means for performing any of the aspects described in connection with the flowcharts in FIG. 8 or 9, and/or performed by the UE in the communication flow of FIG. 7. The means may be the FRB configuration component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the FRB configuration component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, one or more antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the FRB configuration component 199 may be configured to transmit a FRB configuration for a FRB comprising a set of activated REs associated with the FRB configuration in each of a plurality of PRBs and transmit, based on the FRB configuration, a transmission via at least the FRB. The FRB configuration component 199 may be within one or more processors of one or more of the CU 1310, DU 1330, and the RU 1340. The FRB configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for transmitting a flexible resource block (FRB) configuration for a FRB comprising a set of activated resource elements (REs) associated with the FRB configuration in each of a plurality of physical resource blocks (PRBs). The network entity 1302 may include means for transmitting, based on the FRB configuration, a transmission via at least the FRB. The network entity 1302 may include means for increasing a power density of the transmission within the set of activated REs above the PFD threshold based on the set of activated REs having the smaller frequency range than the reference bandwidth for the PFD threshold. The network entity 1302 may further include means for performing any of the aspects described in connection with the flowcharts in FIG. 10 or 11, and/or performed by the network nodes in the communication flow of FIG. 7. The means may be the FRB configuration component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 10 and 11.

FIG. 14 is a diagram 1400 illustrating an example of a hardware implementation for a network entity 1460. In one example, the network entity 1460 may be within the core network 120. The network entity 1460 may include at least one network processor 1412. The network processor(s) 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The network processor(s) 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the FRB configuration component 199 may be configured to transmit a FRB configuration for a FRB comprising a set of activated REs associated with the FRB configuration in each of a plurality of PRBs and transmit, based on the FRB configuration, a transmission via at least the FRB. The FRB configuration component 199 may be within the network processor(s) 1412. The FRB configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1460 may include a variety of components configured for various functions. In one configuration, the network entity 1460 may include means for transmitting a flexible resource block (FRB) configuration for a FRB comprising a set of activated resource elements (REs) associated with the FRB configuration in each of a plurality of physical resource blocks (PRBs). The network entity 1460 may include means for transmitting, based on the FRB configuration, a transmission via at least the FRB. The network entity 1460 may include means for increasing a power density of the transmission within the set of activated REs above the PFD threshold based on the set of activated REs having the smaller frequency range than the reference bandwidth for the PFD threshold. The network entity 1460 may further include means for performing any of the aspects described in connection with the flowcharts in FIG. 10 or 11, and/or performed by the network nodes in the communication flow of FIG. 7. The means may be the FRB configuration component 199 of the network entity 1460 configured to perform the functions recited by the means or as described in relation to FIGS. 10 and 11.

Various aspects relate generally to using an “interlace structure” to cope with, or overcome, issues arising from the PFD limitation in FR2-NTN for handsets (e.g., wireless devices and/or UEs). Some aspects more specifically relate to using a FRB that may be mapped to REs or sub-carriers of a plurality of PRBs (e.g., where the mapping may be a configurable, or flexible, mapping) to achieve a positive SNR while not exceeding the PFD limit. In some examples, a UE may be configured to obtain a FRB configuration for a FRB comprising a set of activated REs associated with the FRB configuration in each of a plurality of PRBs and receive, based on the FRB configuration, a transmission via at least one FRB. In some aspects, a network node (e.g., a satellite) may be configured to transmit a FRB configuration for a FRB comprising a set of activated REs associated with the FRB configuration in each of a plurality of PRBs and transmit, based on the FRB configuration, a transmission via at least the FRB.

Particular aspects of the subject matter described in this disclosure can be implemented to realize one or more of the following potential advantages. In some examples, by using the FRBs, the described techniques can be used to achieve a threshold (positive) SNR or other measure of link quality while not exceeding a PFD limit (e.g., a PFD limit imposed by one or more regulatory bodies/authorities/agencies such as the ITU or the FCC).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: obtaining a flexible resource block (FRB) configuration for a FRB comprising a set of activated resource elements (REs) associated with the FRB configuration in each of a plurality of physical resource blocks (PRBs); and receiving, based on the FRB configuration, a transmission via at least one FRB.

Aspect 2 is the method of aspect 1, wherein the transmission is received from a non-terrestrial network (NTN) node via the at least one FRB.

Aspect 3 is the method of any of aspects 1 and 2, wherein the plurality of PRBs comprises a set of consecutive PRBs, and wherein the set of activated REs has a smaller frequency range than a reference bandwidth for a power flux density (PFD) threshold.

Aspect 4 is the method of aspect 3, wherein sets of activated REs in adjacent PRBs in the set of consecutive PRBs are separated by one or more REs that are within the adjacent PRBs and are not used to transmit a signal associated with the FRB configured by the FRB configuration.

Aspect 5 is the method of any of aspects 1 to 4, wherein the FRB comprises 12 REs.

Aspect 6 is the method of any of aspects 1 to 5, wherein the FRB configuration identifies a first number of the activated REs in the set of activated REs in each of the plurality of PRBs and an offset value indicating a second number of REs from a first RE of each of the plurality of PRBs at which the set of activated REs begins.

Aspect 7 is the method of aspect 6, wherein the FRB configuration is based on at least a power flux density (PFD) limit for a reference frequency range, and the transmission is received in the first number of the activated REs with a PFD that is greater than the PFD limit for the reference frequency range based on the first number of the activated REs spanning less than the reference frequency range such that the PFD averaged over the reference frequency range is lower than the PFD limit for the reference frequency range.

Aspect 8 is the method of aspect 7, wherein the reference frequency range is smaller than a frequency range spanned by one PRB.

Aspect 9 is the method of any of aspects 1 to 8, wherein the FRB configuration is associated with a particular synchronization signal block (SSB) and is received via a system information block (SIB) associated with the SSB.

Aspect 10 is the method of any of aspects 1 to 9, wherein a demodulation reference signal (DMRS) associated with the FRB is mapped to the set of activated REs in each of the plurality of PRBs.

Aspect 11 is the method of any of aspects 1 to 10, wherein the FRB configuration is a first FRB configuration, the FRB is a first FRB, the set of activated REs is a first set of activated REs, the plurality of PRBs is a first plurality of PRBs, and the first FRB configuration is associated with a first network node of a first non-terrestrial network (NTN), the method further comprising: obtaining, from a second NTN node of the first NTN, a second FRB configuration for a second FRB comprising a second set of activated REs associated with the second FRB configuration in each of a second plurality of PRBs, wherein the first and second plurality of PRBs comprise at least one common PRB and the second set of activated REs is disjoint from the first set of activated REs within the at least one common PRB; and receiving, based on the second FRB configuration, an additional transmission via at least one additional FRB.

Aspect 12 is a method of wireless communication at a network node, comprising: transmitting a flexible resource block (FRB) configuration for a FRB comprising a set of activated resource elements (REs) associated with the FRB configuration in each of a plurality of physical resource blocks (PRBs); and transmitting, based on the FRB configuration, a transmission via at least the FRB.

Aspect 13 is the method of aspect 12, wherein the network node is a non-terrestrial network (NTN) node.

Aspect 14 is the method of any of aspects 12 and 13, wherein the plurality of PRBs comprises a set of consecutive PRBs, and wherein the set of activated REs has a smaller frequency range than a reference bandwidth for a power flux density (PFD) threshold.

Aspect 15 is the method of aspect 14, wherein transmitting the transmission includes increasing a power density of the transmission within the set of activated REs above the PFD threshold based on the set of activated REs having the smaller frequency range than the reference bandwidth for the PFD threshold.

Aspect 16 is the method of aspect 15, wherein the reference frequency range is smaller than a frequency range spanned by one PRB.

Aspect 17 is the method of any of aspects 14 to 16, wherein sets of activated REs in adjacent PRBs in the set of consecutive PRBs are separated by one or more REs that are within the adjacent PRBs and are not used to transmit a signal associated with the FRB configured by the FRB configuration.

Aspect 18 is the method of any of aspects 12 to 17, wherein the FRB comprises 12 REs.

Aspect 19 is the method of any of aspects 12 to 18, wherein the FRB configuration identifies a first number of the activated REs in the set of activated REs in each of the plurality of PRBs and an offset value indicating a second number of REs from a first RE of each of the plurality of PRBs at which the set of activated REs begins.

Aspect 20 is the method of any of aspects 12 to 19, wherein the FRB configuration is associated with a particular synchronization signal block (SSB) and is transmitted via a system information block (SIB) associated with the SSB.

Aspect 21 is the method of any of aspects 12 to 20, wherein a demodulation reference signal (DMRS) associated with the FRB is mapped to the set of activated REs in each of the plurality of PRBs.

Aspect 22 is an apparatus for wireless communication at a device including a memory and at least one processor coupled to the memory and, based at least in part on information stored in the memory, the at least one processor is configured to implement any of aspects 1 to 11.

Aspect 23 is the apparatus of aspect 22, further including a transceiver or an antenna coupled to the at least one processor.

Aspect 24 is an apparatus for wireless communication at a device including means for implementing any of aspects 1 to 11.

Aspect 25 is a computer-readable medium (e.g., a non-transitory computer-readable medium) storing computer executable code, where the code when executed by a processor causes the processor to implement any of aspects 1 to 11.

Aspect 26 is an apparatus for wireless communication at a device including a memory and at least one processor coupled to the memory and, based at least in part on information stored in the memory, the at least one processor is configured to implement any of aspects 12 to 21.

Aspect 27 is the apparatus of aspect 26, further including a transceiver or an antenna coupled to the at least one processor.

Aspect 28 is an apparatus for wireless communication at a device including means for implementing any of aspects 12 to 21.

Aspect 29 is a computer-readable medium (e.g., a non-transitory computer-readable medium) storing computer executable code, where the code when executed by a processor causes the processor to implement any of aspects 12 to 21.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
obtain a flexible resource block (FRB) configuration for a FRB comprising a set of activated resource elements (REs) associated with the FRB configuration in each of a plurality of physical resource blocks (PRBs); and
receive, based on the FRB configuration, a transmission via at least one FRB.

2. The apparatus of claim 1, further comprising a transceiver coupled to the at least one processor, the transceiver being configured to receive the transmission from a non-terrestrial network (NTN) node via the at least one FRB.

3. The apparatus of claim 1, wherein the plurality of PRBs comprises a set of consecutive PRBs, and wherein the set of activated REs has a smaller frequency range than a reference bandwidth for a power flux density (PFD) threshold.

4. The apparatus of claim 3, wherein sets of activated REs in adjacent PRBs in the set of consecutive PRBs are separated by one or more REs that are within the adjacent PRBs and are not configured to be used to transmit a signal associated with the FRB configured by the FRB configuration.

5. The apparatus of claim 1, wherein the FRB comprises 12 REs.

6. The apparatus of claim 1, wherein the FRB configuration identifies a first number of the activated REs in the set of activated REs in each of the plurality of PRBs and an offset value indicating a second number of REs from a first RE of each of the plurality of PRBs at which the set of activated REs begins.

7. The apparatus of claim 6, wherein the FRB configuration is based on at least a power flux density (PFD) limit for a reference frequency range, and wherein, to receive the transmission, the at least one processor, individually or in any combination, is further configured to receive the transmission in the first number of the activated REs with a PFD that is greater than the PFD limit for the reference frequency range based on the first number of the activated REs spanning less than the reference frequency range such that the PFD averaged over the reference frequency range is lower than the PFD limit for the reference frequency range.

8. The apparatus of claim 7, wherein the reference frequency range is smaller than a frequency range spanned by one PRB.

9. The apparatus of claim 1, wherein the FRB configuration is associated with a particular synchronization signal block (SSB) and wherein, to obtain the FRB configuration, the at least one processor, individually or in any combination, is further configured to receive the FRB configuration via a system information block (SIB) associated with the SSB.

10. The apparatus of claim 1, wherein a demodulation reference signal (DMRS) associated with the FRB is configured to be mapped to the set of activated REs in each of the plurality of PRBs.

11. The apparatus of claim 1, wherein the FRB configuration is a first FRB configuration, the FRB is a first FRB, the set of activated REs is a first set of activated REs, the plurality of PRBs is a first plurality of PRBs, and the first FRB configuration is associated with a first network node of a first non-terrestrial network (NTN), wherein the at least one processor, individually or in any combination, is further configured to:
obtain, from a second NTN node of the first NTN, a second FRB configuration for a second FRB comprising a second set of activated REs associated with the second FRB configuration in each of a second plurality of PRBs, wherein the first and second plurality of PRBs comprise at least one common PRB and the second set of activated REs is disjoint from the first set of activated REs within the at least one common PRB; and
receive, based on the second FRB configuration, an additional transmission via at least one additional FRB.

12. A method of wireless communication at a user equipment (UE), comprising:
obtaining a flexible resource block (FRB) configuration for a FRB comprising a set of activated resource elements (REs) associated with the FRB configuration in each of a plurality of physical resource blocks (PRBs); and
receiving, based on the FRB configuration, a transmission via at least one FRB.

13. The method of claim 12, wherein the transmission is received from a non-terrestrial network (NTN) node via the at least one FRB.

14. The method of claim 12, wherein the plurality of PRBs comprises a set of consecutive PRBs, wherein the set of activated REs has a smaller frequency range than a reference bandwidth for a power flux density (PFD) threshold, and wherein sets of activated REs in adjacent PRBs in the set of consecutive PRBs are separated by one or more REs that are within the adjacent PRBs and are not used to transmit a signal associated with the FRB configured by the FRB configuration.

15. The method of claim 12, wherein the FRB comprises 12 REs and wherein the FRB configuration identifies a first number of the activated REs in the set of activated REs in each of the plurality of PRBs and an offset value indicating a second number of REs from a first RE of each of the plurality of PRBs at which the set of activated REs begins.

16. The method of claim 15, wherein the FRB configuration is based on at least a power flux density (PFD) limit for a reference frequency range, and the transmission is received in the first number of the activated REs with a PFD that is greater than the PFD limit for the reference frequency range based on the first number of the activated REs spanning less than the reference frequency range such that the PFD averaged over the reference frequency range is lower than the PFD limit for the reference frequency range, and wherein the reference frequency range is smaller than a frequency range spanned by one PRB.

17. The method of claim 12, wherein the FRB configuration is associated with a particular synchronization signal block (SSB) and is received via a system information block (SIB) associated with the SSB.

18. The method of claim 12, wherein a demodulation reference signal (DMRS) associated with the FRB is mapped to the set of activated REs in each of the plurality of PRBs.

19. The method of claim 12, wherein the FRB configuration is a first FRB configuration, the FRB is a first FRB, the set of activated REs is a first set of activated REs, the plurality of PRBs is a first plurality of PRBs, and the first FRB configuration is associated with a first network node of a first non-terrestrial network (NTN), the method further comprising:
obtaining, from a second NTN node of the first NTN, a second FRB configuration for a second FRB comprising a second set of activated REs associated with the second FRB configuration in each of a second plurality of PRBs, wherein the first and second plurality of PRBs comprise at least one common PRB and the second set of activated REs is disjoint from the first set of activated REs within the at least one common PRB; and
receiving, based on the second FRB configuration, an additional transmission via at least one additional FRB.

20. A computer-readable medium storing computer executable code at a user equipment (UE), the code when executed by a processor causes the processor to:
obtain a flexible resource block (FRB) configuration for a FRB comprising a set of activated resource elements (REs) associated with the FRB configuration in each of a plurality of physical resource blocks (PRBs); and
receive, based on the FRB configuration, a transmission via at least one FRB.
